(19) United States
(12) Patent Application Publication
(10) Pub. No.: US 2006/0071474 A1
(43) Pub. Date: Apr. 6, 2006

(54) Threaded connection for drill pipes

(75) Inventors: Thomas A.M. Hallett, Edmonton (CA); Randy Wiltermuth, Edmonton (CA)

Correspondence Address: DYKAS, SHAVER & NIPPER, LLP, P.O. BOX 877, BOISE, ID, 83701-0877, US

(73) Assignee: Argus Machine Co., Ltd., Edmonton (CA)

(21) Appl. No.: 11/007,722

(22) Filed: Dec. 7, 2004

(30) Foreign Application Priority Data
Sep. 28, 2004 (CA) 2,481,609

(51) Int. Cl. F16L 25/00

(52) U.S. Cl. 285/333

(57) ABSTRACT

A pin and box of a threaded connection are provided with interference fit metal-to-metal seals on both sides of a reverse thread section. The pin nose and box nose respectively are received in undercuts in the box shoulder and nose shoulder. The pin nose and box nose engage the respective shoulders at the same time on make-up. The thread section has a low profile, and the pin and box are kept short to reduce bending stresses.

### PRIORITY

This application claims the priority date of the Canadian application entitled Threaded Connection for Drill Pipes filed by Thomas A. M. Hallett on Sep. 28, 2004 with application number 2,481,609.

### DESCRIPTION

### BACKGROUND OF THE INVENTION

Background Information. Horizontal and directional drilling allows drill rig operators to follow multiple pre-planned drilling paths from a single well-head. Advances in drill tools permit accurate location of the drill bit and steering of the drill bit along the pre-planned drilling path. Drilling multiple drill holes from a single well-head necessitates that the drill string follow an arcuate path. Drill pipe used in directional drilling may be thin-walled 5¼ OD pipe with a ¼ inch wall thickness. At the threaded connections between adjacent drill pipes in the drill string, the walls of the pins and boxes narrow to less than ⅛ inch. Providing a threaded connection in such drill pipe that can withstand high compressive, tensile and bending stresses poses a significant design challenge.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE FNVENTION

An improved threaded connection for use in drill pipe, as for example used in directional drilling along curved paths, is therefore provided that can withstand high compressive, tensile and bending stresses. A pin and box of a threaded connection are provided with interference fit metal-to-metal seals on both sides of a reverse thread section. In further aspects of the invention, the pin nose and box nose respectively are received in undercuts in the box shoulder and nose shoulder. In a further aspect of the invention, the pin nose and box nose engage the respective shoulders at the same time on make-up. Preferably, the thread section has a low profile, and the pin and box are kept short to reduce bending stresses.

These and other aspects of the invention are described in the detailed description of the invention and claimed in the claims that follow.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

There will now be described preferred embodiments of the invention, with reference to the drawings, by way of illustration only and not with the intention of limiting the scope of the invention, in which like numerals denote like elements and in which:

FIG. 1 shows a section through a made-up pin and box connection according to the invention.

FIG. 2 is a section through the pin of FIG. 1.

FIG. 2A is a detail of a pin shoulder and pin shoulder seal of the pin of FIG. 2.

FIG. 2B is a detail of an external thread section on the pin of FIG. 2.

FIG. 2C is a detail of a pin nose and pin nose seal of the pin of FIG. 2.

FIG. 3 is a section through the box of FIG. 1.

FIG. 3A is a detail of a box nose and box nose seal of the box of FIG. 3.

FIG. 3B is a detail of an internal thread section on the box of FIG. 3.

FIG. 3C is a detail of a box shoulder and box shoulder seal of the box of FIG. 3.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In this patent application, the use of the word comprising does not exclude other elements being present. In addition, a reference to an element by the indefinite article “a” does not exclude the possibility that more than one of the elements is present.

The threaded connection of the present invention is designed for use on a drill pipe that is to be used for drilling along an arcuate path in a drill string made up of connected lengths of cooperating drill pipes. A typical use would be in horizontal drilling.

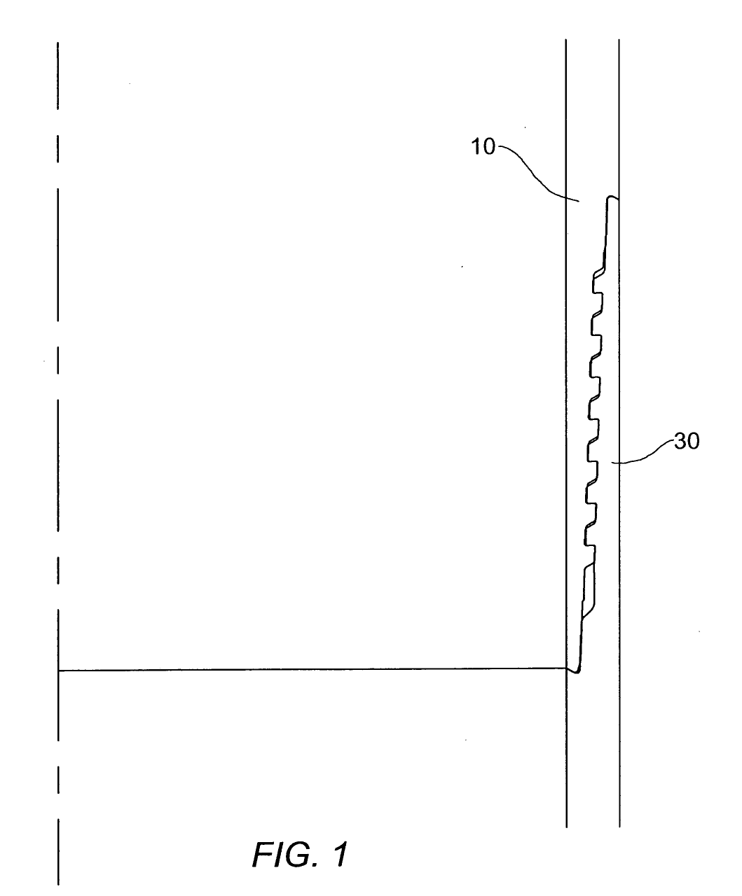

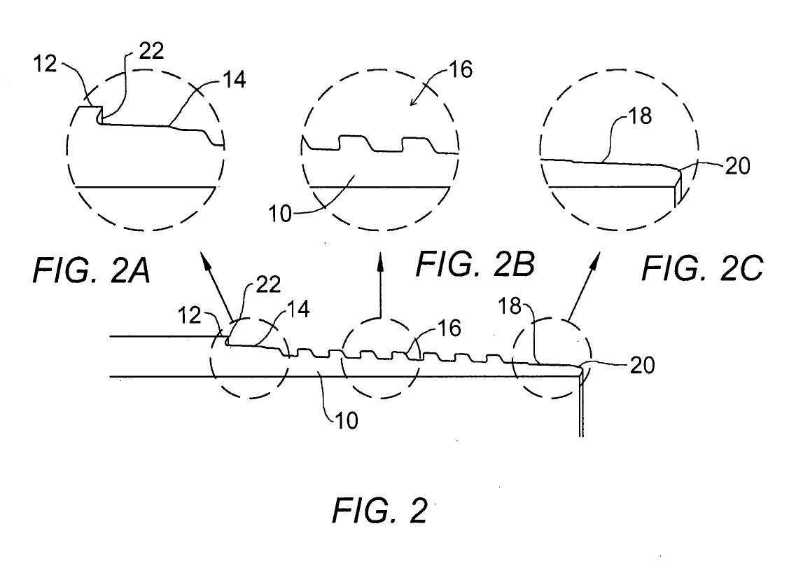

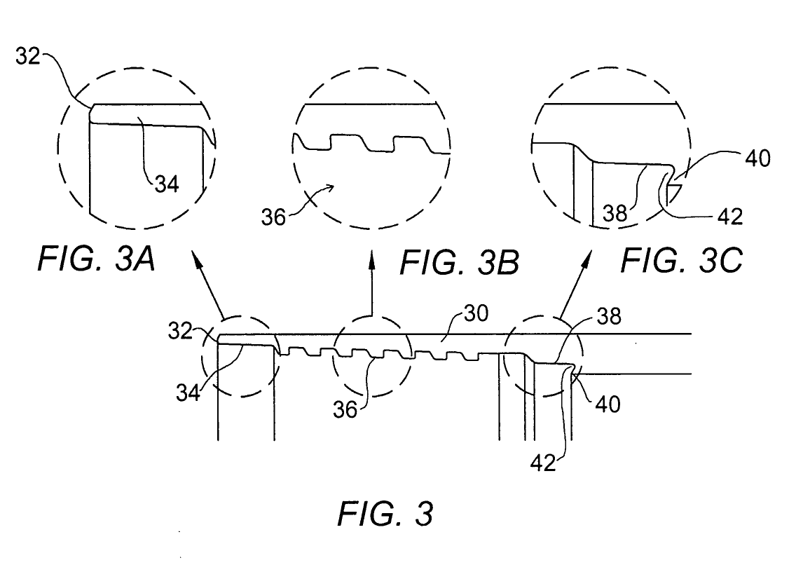

Referring to FIG. 1, the threaded connection is formed from a pin 10 and box 30. As shown in FIG. 2 and in more detail in FIGS. 2A, 2B and 2C, pin 10 has in order a pin shoulder 12, pin shoulder seal surface 14, external thread section 16, pin nose seal surface 18 and pin nose 20. As shown in FIG. 3 and in more detail in FIGS. 3A, 3B and 3C, box 30 has in order a box nose 32, box nose seal surface 34, internal thread section 36, box shoulder seal surface 38 and box shoulder 40. The external thread section 16 and internal thread section 36 each have cooperating reverse angle threads that provide a radially compressive force upon make-up of the threaded connection.

The following dimensions of the threads have been found suitable for a 5¼ inch drill pipe with a ¼ inch wall thickness: the reverse angle may be about 5°, the pitch of the exterior and interior threads may be 0.2 inches, with the width of the thread roots being about 0.095 inches, the slope of the thread form opposed to the reverse angle may be 30°, the profile of the pin threads may be 0.045 inches, and is preferably less than 0.050 inches, the profile of the box threads may be 0.047 inches, and is preferably slightly (0.002 inches) more than the profile of the pin threads to allow for a small spacing between the threads where pipe thread dope in the connection may flow, and there are 6-8 thread flights. The pin tapers at about ¾ inch per 12 inches. The low profile threads and minimal clearance from thread diameter to seal diameter thus unable this connection to cut on very thin walled pipe (for example ¼ inch thick wall).

The pin 10 and box 30 are dimensioned so that upon make-up of the threaded connection, the pin shoulder seal surface 14 contacts the box nose seal surface 34 to form a radially compressed metal-to-metal seal over an area between the pin shoulder 12 and external thread section 16. The pin 10 and box 30 are also dimensioned so that upon make-up of the threaded connection, the pin nose seal surface 18 contacts the box shoulder seal surface 38 to form a radially compressed metal-to-metal seal over an area between the box shoulder 40 and internal thread section 36. The length of each seal area for a 5¼ inch drill pipe is at least ¼ inch. The radial compression is produced by an interference fit at the metal-to-metal seals enhanced by radial compression from the make-up of the reverse angle threads. The interference fit enhances the connection's ability to carry a high load in tension. The interference fit at the seal areas also relieves some of the bending stress in the threaded portions.

The pin shoulder 12 is reverse angled, for example at 30°, to form a pin undercut 22, and the box nose 32 engages the pin undercut 22 upon make-up of the threaded connection. The undercut of the pin shoulder 12 helps prevent the box nose 32 from splaying outward under compressive strain. It is desirable for the pin shoulder 12 to have a sizable thickness to assist in preventing the belling out of the shoulder 12 under compressive strain, such as is provided in the instance of the example given here by the shoulder 12 stepping outward about 0.055 inches (change in OD of the pin across the shoulder being about 0.115 inches) with a reverse angle of 30°. The box nose 32 should be shaped complementarily to the pin shoulder 12.

The box shoulder 40 is also reverse angled to form a box undercut 42, and the pin nose 20 engages the box undercut 42 upon make-up of the threaded connection. The undercut of the box shoulder 40 helps prevent the pin nose 20 from splaying inward. It is desirable likewise for the box shoulder 40 to have a sizable thickness to assist in preventing the belling out of the shoulder 40, such as is provided in the instance of the example given here by the shoulder 40 stepping outward about 0.055 inches (change in OD of the pin across the shoulder being about 0.115 inches) with a reverse angle of 30°. The pin nose 20 should be shaped complementarily to the box shoulder 12.

The pin and box are dimensioned such that, upon make-up of the threaded connection, the pin nose 20 engages the box undercut 42 at the same time as the box nose 32 engages the pin undercut 22. For example, the distances between the deepest portions of the undercuts 22, 42 from the farthest extensions of the respective noses 32, 20 may both be 2.267 inches. This increases the connection's ability to transmit radial torque on thin-walled section pipe (eg 5¼ inch pipe with a ¼ inch wall) by increasing the available end area in compression.

Excluding the undercut length from the length of the pin and box connection yields a pin and box connection of 2.25 inches. On exemplary 5¼ inch drill pipe used for horizontal drilling, a threaded connection less than about 3 inches long reduces bend loads and tends to stay straight as the pipe drills around a bend, and thus will be more likely to retain its structural integrity over extended periods of use.

A threaded connection having the design described here and made in API Grade Q-125 Casing (5½″ OD, turned the OD and bored the ID) showed a yield tensile load of 260,000 lbs. and an ultimate tensile load of 324,000 lbs. Other materials may be used depending on corrosion, cost and desired yield level.

Immaterial modifications may be made to the embodiments described here without departing from the invention.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A threaded connection, comprising:
a pin having in order a pin shoulder, pin shoulder seal surface, external thread section, pin nose seal surface and pin nose;
a box having in order a box nose, box nose seal surface, internal thread section, box shoulder seal surface and box shoulder;
the external thread section and internal thread section each having cooperating reverse angle threads that provide a radially compressive force upon make-up of the threaded connection; and
the pin and box being dimensioned so that upon make-up of the threaded connection, the pin shoulder seal surface contacts the box nose seal surface to form a first radially compressed metal-to-metal seal over an area between the pin shoulder and external thread section and the pin nose seal surface contacts the box shoulder seal surface to form a second radially compressed metal-to-metal seal over an area between the box shoulder and internal thread section.

2. The threaded connection of claim 1 in which the pin shoulder is reverse angled to form a pin undercut, and the box nose engages the pin undercut upon make-up of the threaded connection.

3. The threaded connection of claim 1 in which the box shoulder is reverse angled to form a box undercut, and the pin nose engages the box undercut upon make-up of the threaded connection.

4. The threaded connection of claim 3 in which the pin shoulder is reverse angled to form a pin undercut, and the box nose engages the pin undercut upon make-up of the threaded connection.

5. The threaded connection of claim 4 in which the pin and box are dimensioned such that, upon make-up of the threaded connection, the pin nose engages the box undercut at the same time as the box nose engages the pin undercut.

6. The threaded connection of claim 1 in which each of the first and second radially compressed metal-to-metal seals is at least ¼ inch long.

7. The threaded connection of claim 1 in which the pin and box are each less than 3 inches in length.

8. The threaded connection of claim 1 in which the reverse angle threads have a thread form with a profile of less than 0.050 inches.

9. A drill pipe for drilling along an arcuate path in a drill string made up of connected lengths of cooperating drill pipes, with threaded pin and box connections between the cooperating drill pipes, the drill pipe comprising:
a pin having in order a pin shoulder, pin shoulder seal surface, external thread section, pin nose seal surface and pin nose;
a box having in order a box nose, box nose seal surface, internal thread section, box shoulder seal surface and box shoulder;
the external thread section and internal thread section each having cooperating reverse angle threads that provide a radially compressive force upon make-up of the drill pipe with a cooperating drill pipe; and
the pin and box being dimensioned so that upon make-up of threaded connections with adjacent cooperating drill pipes, the pin shoulder seal surface of the drill pipe contacts the box nose seal surface of a cooperating drill pipe to form a first radially compressed metal-to-metal seal over an area between the pin shoulder and external thread section and the pin nose seal surface contacts the box shoulder seal surface of a cooperating drill pipe to form a second radially compressed metal-to-metal seal over an area between the box shoulder and internal thread section.

10. The drill pipe of claim 9 in which the pin shoulder is reverse angled to form a pin undercut, and the box nose engages the pin undercut upon make-up of a threaded connection with a cooperating drill pipe.

11. The drill pipe of claim 9 in which the box shoulder is reverse angled to form a box undercut, and the pin nose engages the box undercut upon make-up of a threaded connection with a cooperating drill pipe.

12. The drill pipe of claim 11 in which the pin shoulder is reverse angled to form a pin undercut, and the box nose engages the pin undercut upon make-up of the threaded connection.

13. The drill pipe of claim 12 in which the pin and box are dimensioned such that, upon make-up of the threaded connection, the pin nose engages the box undercut at the same time as the box nose engages the pin undercut.

14. The drill pipe of claim 9 in which each of the first and second radially compressed metal-to-metal seals is at least ¼ inch long.

15. The drill pipe of claim 9 in which the pin and box are each less than 3 inches in length.

16. The drill pipe of claim 9 in which the reverse angle threads have a thread form with a profile of less than 0.050 inches.
